(19) United States
(12) Patent Application Publication
(10) Pub. No.: US 2017/0183249 A1
(43) Pub. Date: Jun. 29, 2017

(54) GLASS MELTING PLANT AND METHOD FOR THE OPERATION THEREOF

(71) Applicant: Beteiligungen Sorg GmbH & Co. KG, Lohr am Main (DE)

(72) Inventors: Volker MÜLLER, Tettau (DE); Jürgen GRÖSSLER, Karlstadt (DE)

(21) Appl. No.: 15/386,801

(22) Filed: Dec. 21, 2016

(30) Foreign Application Priority Data
Dec. 29, 2015 (DE) 102015122912.9

(51) Int. Cl. C03B 5/235; C03B 5/02

(52) U.S. Cl. CPC C03B 5/235; C03B 5/02

(57) ABSTRACT

A glass melting plant having a fully electrically heated melt tank and a conditioning channel connected to the melt tank. In order to enable the recovery of wet waste without impairing the glass quality, in addition, a wet waste supply channel is provided, which opens laterally into the conditioning channel, for the melting of wet waste and for supplying the melted wet waste to the glass melt conducted in the conditioning channel. A corresponding method is provided for operating a glass melting plant.

### CROSS-REFERENCES TO RELATED. APPLICATIONS

This application claims the benefit of the German patent application No. 10 2015 122 912.9 filed on Dec. 29, 2015, the entire disclosures of which are incorporated herein by way of reference.

### BACKGROUND OF THE INVENTION

The present invention relates to a fully electrically heated, two-chambered glass melting plant, having a melt tank and having a conditioning channel, also called a working tank, connected to the melt tank via a passage. In the melt tank, the solid initial materials are gradually completely melted by electrically operated heating elements. In the conditioning channel, the glass melt, which there no longer has any solid components, is set in controlled fashion to a processing temperature, and is finally released via an outlet system for further processing. The channel-shaped passage connects the melt tank to the conditioning channel, and frequently has a smaller width and/or height than the melt tank and/or the conditioning channel.

The addition of materials to a glass melting plant standardly takes place in the region of the melt tank, e.g., via a doghouse. For example, EP 1 093 442 B1 discloses that batch including raw materials is fed laterally via supply channels to the rear area of the melt tank, which is situated opposite an outlet for the glass melt. In addition, an opening is provided at the end wall present in this region, through which glass cullet and shards are supplied to the melt tank.

In the production of fiberglass for mineral wool products, in particular the production of chemical glass, so-called wet waste occurs during production. This is manufacturing waste made up of fibers that are already coated with a coating that has an organic basis. Such coating materials are, for example, phenol formaldehyde resin, polymer polyacids such as polyacrylic acid having polyols such as ethylene glycol, glycerin, glucose, etc. The coating materials are in part difficult to remove thermally, and influence the composition of a glass melt if the fibers are added to the melt. In this way, the corrosion rate of the oven may increase.

Wet waste is usually present in the form of pellets that can have a residual moisture of at most 30 wt %. The wet waste is currently discarded. Discarding the wet waste is disadvantageous, because of the associated costs and because the already-produced glass material is lost. It is therefore desirable to resupply this wet waste to the production process.

From U.S. Pat. No. 4,432,780 A, a glass melting plant is known in which the fiberglass waste is supplied to the melt tank by means of an oxidizing gas stream. This gas stream, for example air, transports the coated glass fibers into the region of hot oxidizing gases above the glass melt in order to oxidize at least a part of the coating of the surface of the fibers. Here, the fibers are present in pulverized form, for example having a size of 1¼ inch. According to the disclosure of U.S. Pat. No. 4,432,780 A, the supply lines for the gas stream provided with the fibers can be situated in the end wall situated opposite the flue, in the side walls, and also in the end wall of the melt tank, situated at the end of the outlet of the melt tank. However, this conventional method for introducing glass fibers has the disadvantage that the composition of the glass melt in the melt tank is changed for the worse, and the corrosion of the tank is accelerated.

US 2002/000100 A1 indicates that the fiber waste can be supplied to an electrically heated melt oven together with the batch. This reference further discloses that the fiber waste material is supplied to a region of the melt tank via a channel situated above the melt, in which channel the temperature of the melt is at least 1000° C. In order to ensure that the fibers actually reach the melt bath, the waste material is moreover moistened with water. This known method also does not achieve the desired results with regard to the quality of the glass melt.

### SUMMARY OF THE INVENTION

An object of the present invention is therefore to create a glass melting plant having a fully electrically heated melt tank that enables recovery of the wet waste, such that the glass production is not permitted to be impaired thereby, in particular with regard to the glass quality. Correspondingly, the object is to indicate a simple and low-cost method that realizes the recovery of the wet waste.

In particular, in the glass melting plant according to the present invention, a wet waste supply channel is additionally provided that opens laterally into the conditioning channel, and is set up to melt wet waste and to supply the melted wet waste to the glass melt carried in the conditioning channel. In addition, according to the present invention, a supply device is provided at the end of the wet waste supply channel situated opposite the conditioning channel. The supply device stores the wet waste, for example in a storage container, and provides the wet waste to the wet waste supply channel. This means that the supply device produces a connection between the supply container and the wet waste supply channel, and the wet waste is transported by the supply device from the supply container into the wet waste supply channel.

The inventors have recognized that, in particular, in a melt technology in which, in a vertically oriented melting process, a cold batch cover made of non-melted material is present above a fully electrically heated melt flow, the melt process is significantly disturbed by the addition of the wet waste in the melt tank. For an optimal melt process, the melt tank must be completely covered at the feed surface, because the covering protects against direct heat radiation loss of the glass melt. If the wet waste were added directly in the melt tank, this cover would tear open, and the thermal balance of the melt tank would be disturbed. The tearing of the cover brings about a direct, unhindered radiation of heat upward, so that the temperatures in the melting plant fall. This has to be compensated by increasing the supply of energy. In this way, the melt process becomes thermally unstable, which also negatively influences the flow conditions in the tank. As a consequence, the quality of the melt leaving the melt aggregate would become worse.

On the basis of this recognition, the inventors have arrived at the result that—differing from the existing art—the addition of the wet waste has to take place in the conditioning channel, in which the thermal balance is independent of the batch covering, because no batch covering is required in the conditioning channel. The inventors have further discovered that it is necessary to completely melt the wet waste before supplying it in a wet waste supply channel that opens laterally into the conditioning channel, in order to thermally influence as little as possible the glass melt conducted in the conditioning channel. Moreover, through the melting of the wet waste, a thermal conditioning of the melted wet waste takes place, with the effect that the material stream coming from the wet waste supply channel has as small a temperature difference as possible from the main stream of the conditioning channel.

Otherwise, if the temperature difference between the temperature of the melted wet waste leaving the wet waste supply channel and the temperature of the glass melt flowing in the conditioning channel at this location is too large, the energy expense required to equalize the temperature in the conditioning channel increases significantly. Given a throughput of the melting plant of 100 t/day and 5% addition of fiber waste with a moistness of 30%, for example, one would have to additionally input a quantity of energy in the amount of 650 kW in the conditioning channel.

In addition, the melting of the wet waste before supplying it into the conditioning channel has the effect that the organic constituents of the wet waste escape the coating as waste gas, and thus do not enter into the glass stream flowing in the conditioning channel.

In the context of the present invention, wet waste is seen as production waste made up of glass fibers, where the glass fibers can have on their surface a coating that at least partly contains an organic compound. The wet waste can, in addition, have a residual moistness of at most 30 wt %. Preferably, the wet waste is present in the form of pellets. The fibers preferably have a length in the range of from 10 mm to 100 mm.

The wet waste supply channel can be heated electrically by an electrode situated in the wet waste melt, and/or atmospherically by a burner that uses gaseous fuel.

In a preferred exemplary embodiment, the wet waste supply channel has a flue through which the waste gas that arises in the wet waste supply channel when the wet waste melts is supplied to a waste gas cleaning plant. This extraction of the waste gas is necessary because when the wet waste melts, water vapor and gaseous organic compounds are released. This should not enter into the conditioning channel, because it attacks the lining of the conditioning channel too strongly.

For the same reason, in a preferred specific embodiment of the present invention, the wet waste supply channel is sealed in gas-tight fashion against the surrounding environment and the conditioning channel.

In addition, it is preferred that the oven pressure in the combustion chamber over the glass melt in the conditioning channel be controlled using a suction pump situated after the waste gas cleaning plant, in the direction of the waste gas flow.

In addition, it is advantageous that, in a preferred specific embodiment of the present invention, a preferably cuboidal skimmer is provided at the end of the wet waste supply channel at the side of the conditioning channel. The skimmer, which preferably extends into the wet waste melt of the supply channel by at least 10 mm, preferably 15 mm to 20 mm, prevents surface glass from entering directly into the conditioning channel. In addition, foam that is formed in the melting of the wet waste, is prevented from entering into the conditioning channel. The skimmer extends, preferably, over the entire width of the wet waste supply channel. In addition, it extends past an inner edge that upwardly terminates the conditioning channel and the wet waste supply channel.

The addition of the wet waste, dosed according to the present invention, takes place at the end of the wet waste supply channel situated opposite the conditioning channel, through the supply device (feeder) through which the, preferably, reduced wet waste is supplied to the wet waste supply channel. Particularly preferably, the supply device has a conveyor device and a supply container having the wet waste, fashioned, for example, as a dosing or supply hopper. The supply container has an inlet opening for supplying the wet waste from the outside, and an outlet opening at the opposite end of the supply container, through which wet waste is transferred to the conveyor device for transport to the wet waste supply channel.

The above-indicated object is further achieved through a method for operating a glass melting plant. The method according to the present invention has the same advantages as the glass melting plant according to the present invention.

According to the present invention, wet waste is melted in a wet waste supply channel, and is supplied to the glass melt conducted in the conditioning channel laterally, i.e., transverse to the direction of flow of the glass melt, through this wet waste supply channel. This method is particularly simple, and has the result that wet waste can now be reclaimed.

As already explained above, it is of particular advantage that the waste gases that arise in the wet waste supply channel due to the melting of the wet waste are supplied, through a flue, to a waste gas cleaning plant.

It is further advantageous if the, preferably pulverized, wet waste is supplied by a supply device to the wet waste supply channel at its end situated opposite the conditioning channel.

The depth of the melt bath in the wet waste supply channel is preferably at least 80 mm, particularly preferably 100 mm to 250 mm.

### BRIEF DESCRIPTION OF THE DRAWINGS

In the following, the present invention is explained in more detail on the basis of exemplary embodiments that are shown in the Figures. All described and/or graphically depicted features, in themselves or in any combination, form the subject matter of the present invention, independent of their summarization in the claims or relations of dependency.

FIG. 1 schematically shows an exemplary embodiment of a glass melting plant according to the present invention in a view from the side,

FIG. 2 schematically shows a wet waste supply channel of the glass melting plant according to FIG. 1, in a view from the side,

FIG. 3 shows the wet waste supply channel according to FIG. 2 in a view from above, and

FIG. 4 shows the glass melting plant according to the present invention according to FIG. 1, in a view from above.

### DETAILED DESCRIPTION OF THE PREFERRED EMBODIMENTS

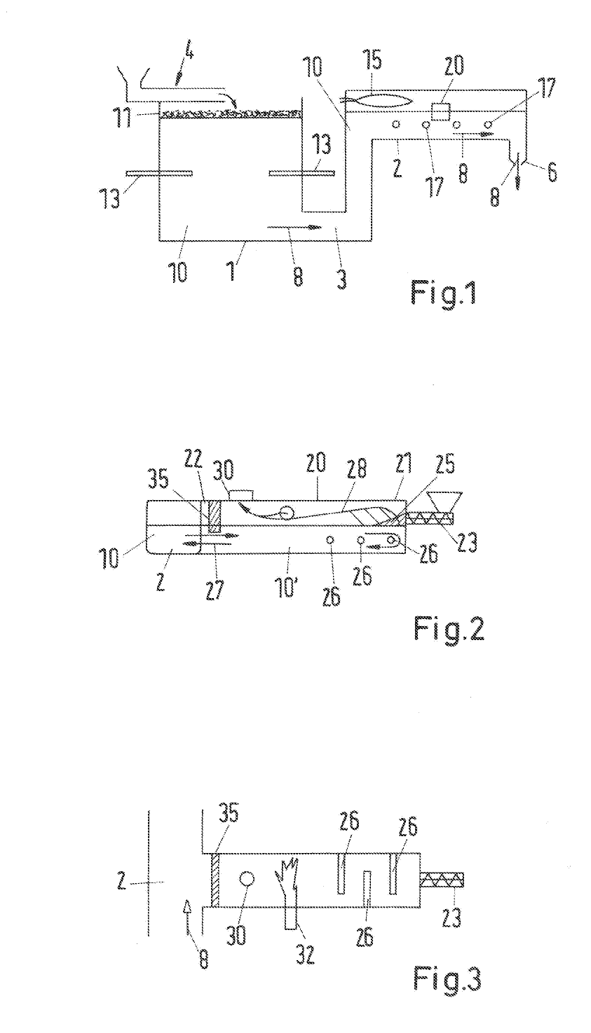

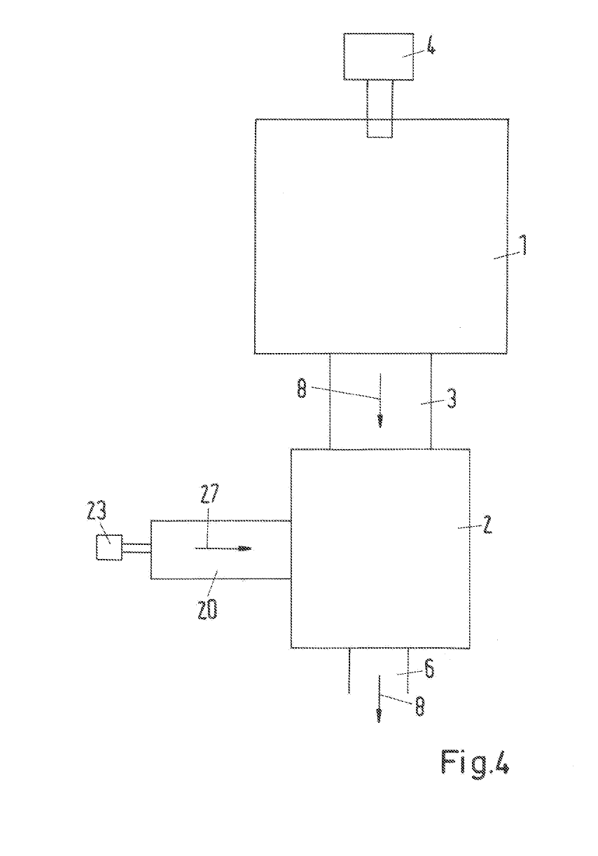

FIGS. 1 and 4 show a glass melting plant according to the present invention having a melt tank 1 and a conditioning channel 2 that is connected to the melt tank 1 via a passage 3. In the melt tank 1, the raw material batch, that is, the initial materials of the glass melt, are placed into melt tank 1 via a supply line 4. The raw material batch can, conventionally, contain primary raw materials and, if warranted, also glass shards. In the non-melted state, it forms a batch cover 11 on the surface of the glass melt 10 in the melt tank 1. Here, in the melt tank 1 the feed surface is mostly covered completely by the batch covering 11, in particular in the case shown here, in which the heating of the melt tank 1 takes place electrically in a known manner using melt electrodes 13 that extend laterally into the melt tank 1.

After the melting in the melt tank 1, the glass melt 10 passes through the passage 3 in the direction of flow (see arrows 8), and moves into the conditioning channel 2, where there takes place a controlled setting of the processing temperature of the glass melt 10 using electrodes 17 situated in the side wall of the conditioning channel 2, and/or using a burner 15 that is set up to burn gaseous fuels such as natural gas. The burner 15 is preferably situated in the end wall of conditioning channel 2, into which passage 3 opens. The glass melt 10 finally exits conditioning channel 2 via an outlet 6 for further processing.

In addition, the conditioning channel 2 is connected to a wet waste supply channel 20 that is shown in detail in FIGS. 2 and 3. The wet waste supply channel 20 opens into a side wall of the conditioning channel 2, transverse to the direction of flow (see arrows 8) of the glass melt 10.

In the wet waste supply channel 20, the wet waste is melted, so that there results a wet waste melt 10′. The wet waste is introduced at the end 21 of the wet waste supply channel 20, which end is opposite the conditioning channel 2, by a supply device 23 that also has a conveyor device (e.g., a helical feeder). The conveyor device here can be made such that it permits adjustment of the conveyed quantity. In addition, a supply container is provided containing the preferably disintegrated wet waste. The wet waste is transported from the supply container to the wet waste supply channel 20 by the conveyor device. The fed, non-melted wet waste batch covers the surface of the wet waste melt 10′ in a region 25.

The heating of the wet waste supply channel 20 takes place using electrodes 26, which extend into the wet waste supply channel 20 laterally, i.e., transverse to the direction of flow 27 of the wet waste melt 10′. The electrodes 26 are situated at the end 21, opposite the conditioning channel 2, of the wet waste supply channel 20.

The wet waste supply channel 20 is further heated for the melting of the wet waste by a burner 32 that introduces gaseous fuel into the wet waste supply channel 20 perpendicular to the direction of flow (see arrow 27) of the wet waste melt 10′.

During the heating of the wet waste there arise waste gases that result, in particular, due to combustion of the coating of the organically-based fibers. The waste gases flow in a direction indicated by arrows 28, and leave via a flue 30. The flue 30 is situated in the region of the end 22, at the conditioning channel, of the wet waste supply channel 20.

The combustion chamber of the wet waste supply channel 20 is also sealed in gas-tight fashion against the surrounding environment, and the waste gases are introduced via the flue 30 into an exhaust gas cleaning plant (not shown). The waste gas of the wet waste supply channel 20 is loaded with pollutants and dust that are filtered out by the waste gas cleaning plant. The pressure in the wet waste supply channel 20 over the wet waste melt 10′, or in the conditioning channel 2 over the glass melt 10, is controlled by an induced draft fan standardly situated after the waste gas cleaning plant in the direction of flow of the waste gas (arrows 28).

The wet waste supply channel 20 further has, at its end 22 at the conditioning channel, a skimmer 35 that the seals wet waste supply channel 20 in a gas-tight fashion against the conditioning channel 2. The skimmer 35, which has the shape of a block, prevents surface glass from the wet waste melt 10′ from entering directly into the conditioning channel 2. In addition, the skimmer 35 can hold back foam that forms during the melting of the wet waste from entering the glass melt 10 flowing in the conditioning channel 2.

The skimmer 35 is made of a corrosion-resistant, fire-resistant material that is also suitable for direct contact with the wet waste melt 10′. Measured from the surface of the wet waste melt 10′, the block extends at least 10 mm, preferably 15 mm to 20 mm, into this melt. The melt bath depth in the conditioning channel 2 and in the wet waste supply channel is preferably at least 80 mm, particularly preferably 100 mm to 250 mm. The skimmer 35 extends past the inner edge of the arch that upwardly terminates the conditioning channel 2 and also the wet waste supply channel 20, so that the skimmer block completely separates the two gas compartments from the supply channel and the conditioning channel. The two gas compartment covers abut this skimmer block. As a result, no gap can arise between the separated gas compartments that would permit an exchange of the respective atmospheres present in the gas compartments.

The glass melting plant according to the present invention, or the method according to the present invention, permit a simple and low-cost recovery of the wet waste without having any significant negative influence on the glass quality.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE CHARACTERS

1 melt tank
2 conditioning channel
3 passage
4 supply device
6 outlet
8 direction of flow of glass melt 10
10 glass melt
10′ wet waste melt
11 batch cover
13 electrode
15 burner
17 electrode
20 wet waste supply channel
21 end of wet waste supply channel 20 situated opposite the conditioning channel
22 end of wet waste supply channel 20 at the conditioning channel side
23 supply device
25 region
26 electrode
27 direction of flow of the wet waste melt
28 direction of the waste gas flow
30 flue
32 burner
35 skimmer

1. A glass melting plant comprising:
a fully electrically heated melt tank,
a conditioning channel connected to the melt tank,
a wet waste supply channel opening laterally into the conditioning channel and being configured to melt wet waste and to supply the melted wet waste to the glass melt conducted in the conditioning channel, and
a supply device located at an end of the wet waste supply channel situated opposite the conditioning channel, the supply device storing the wet waste and supplying it to the wet waste supply channel.

2. The glass melting plant as recited in claim 1, wherein the wet waste supply channel has a flue through which the waste gases that arise in the wet waste supply channel during the melting of the wet waste are supplied to a waste gas cleaning plant.

3. The glass melting plant as recited in claim 1, wherein the wet waste supply channel is sealed in a gas-tight fashion against the surrounding environment and against the conditioning channel.

4. The glass melting plant as recited in claim 1, wherein a skimmer is provided at an end of the wet waste supply channel at the conditioning channel.

5. The glass melting plant as recited in claim 1, wherein the supply device is configured to supply pulverized wet waste to the wet waste supply channel.

6. The glass melting plant as recited in claim 1, wherein the skimmer extends at least 10 mm into the wet waste melt.

7. A method for operating a glass melting plant having a fully electrically heated melt tank and a conditioning channel connected thereto, comprising
melting wet waste in a wet waste supply channel,
supplying the melted wet waste laterally, through the wet waste supply channel, to a glass melt conducted in the conditioning channel.

8. The method as recited in claim 7, including supplying the waste gases, arising in the wet waste supply channel due to the melting of the wet waste, through a flue to a waste gas cleaning plant.

9. The method as recited in claim 7, including supplying the wet waste, by a supply device, to the wet waste supply channel at an end of the wet waste supply channel situated opposite the conditioning channel.

10. The method according to claim 9, including pulverizing the wet waste prior to introducing it into the wet waste supply channel.
